(19) United States
(12) Patent Application Publication
(10) Pub. No.: US 2009/0092949 A1
(43) Pub. Date: Apr. 9, 2009

(54) SYSTEM FOR USE WITH A DROPLET CLEANING DEVICE FOR CLEANING AN IMPACT AREA FOR THE DROPLETS

(75) Inventor: Paul Duineveld, Drachten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/158,280

(22) PCT Filed: Dec. 19, 2006
(86) PCT No.: PCT/IB06/54956

§ 371 Date: Sep. 10, 2008

Related U.S. Application Data
(60) Provisional application No. 60/752,652, filed on Dec. 21, 2005.

(51) Int. Cl. A61C 17/00

(52) U.S. Cl. 433/216

(57) ABSTRACT

The clearing system for fluid droplets includes a source of air (10) which is produced at a given velocity and an air flow directing member (15) for directing the air flow to an area on the teeth which has thereon a liquid film (19) produced by previous landing of high-speed fluid droplets, wherein the velocity of the air flow is high enough to significantly reduce the thickness of the liquid film and thereby increase the efficiency of the fluid droplets in the cleared area on the teeth.

This invention relates generally to high-speed droplet systems for oral cleaning applications, and more specifically concerns a system for clearing a portion of a liquid film present on the teeth due to accumulation of fluid from the droplet system.

In a fluid droplet oral cleaning system, small fluid droplets are generated and then accelerated at high speeds and directed to an application target, for instance, teeth in an oral cleaning application. Such a system has been shown to have advantages in general oral cleaning effectiveness. A system for oral cleaning using fluid droplets is shown, for instance, in U.S. patent application Ser. No. 60/537,690, titled Droplet Jet System For Cleaning, which is owned by the assignee of the present invention. The contents of that application are hereby incorporated by reference.

However, it has been discovered that during operation of such a fluid droplet oral cleaning device, the individual fluid droplets will typically collect in the mouth of the user and will form a film of liquid (fluid) on the teeth. This is most noticeable for the teeth in the lower jaw. Even a thin liquid film, i.e. on the order of 10 microns, will interfere with the cleaning process, as subsequent droplets must pass through the liquid film in order to reach the surface of the teeth. This will seriously affect the efficiency of the plaque removal on the teeth, due to the decrease of the impact velocity of the droplets on the surface of the teeth caused by the liquid film. This disadvantage basically affects all fluid droplet systems, even those using “high-speed” (greater than 30 meters per second) droplets.

Hence, it is desirable to overcome the disadvantage of the presence of a liquid film on the target in order to ensure effective cleaning by a fluid droplet system.

Accordingly, the present invention is a system for clearing the area of impact for a fluid droplet system used for oral cleaning of the teeth, comprising: a source of gas flow; and a gas flow directing member for directing the gas flow to an area on the teeth which has thereon a liquid film produced by fluid droplets, wherein the gas flow has a velocity which is high enough to significantly reduce the thickness of the liquid film so as to increase the efficiency of subsequent fluid droplets directed to the teeth for cleaning action.

FIG. 1 is a schematic diagram illustrating one embodiment of the present invention.

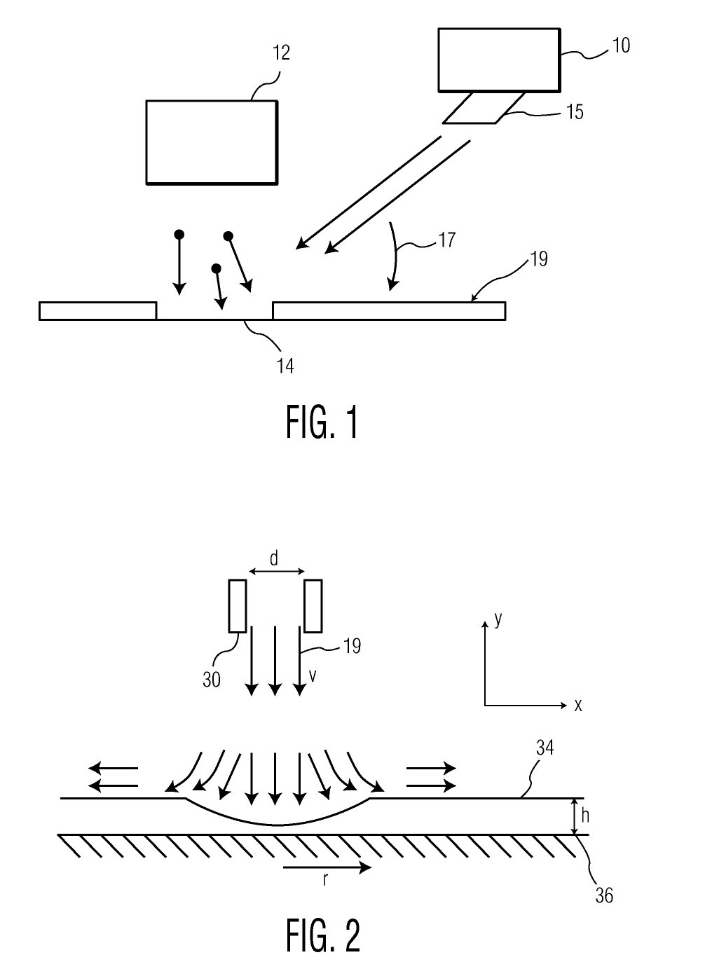

FIG. 2 is a diagram illustrating the effect of the present system on a liquid film.

FIG. 3 is a diagram showing the use of a single system for accelerating the fluid droplets and cleaning the liquid film on the teeth.

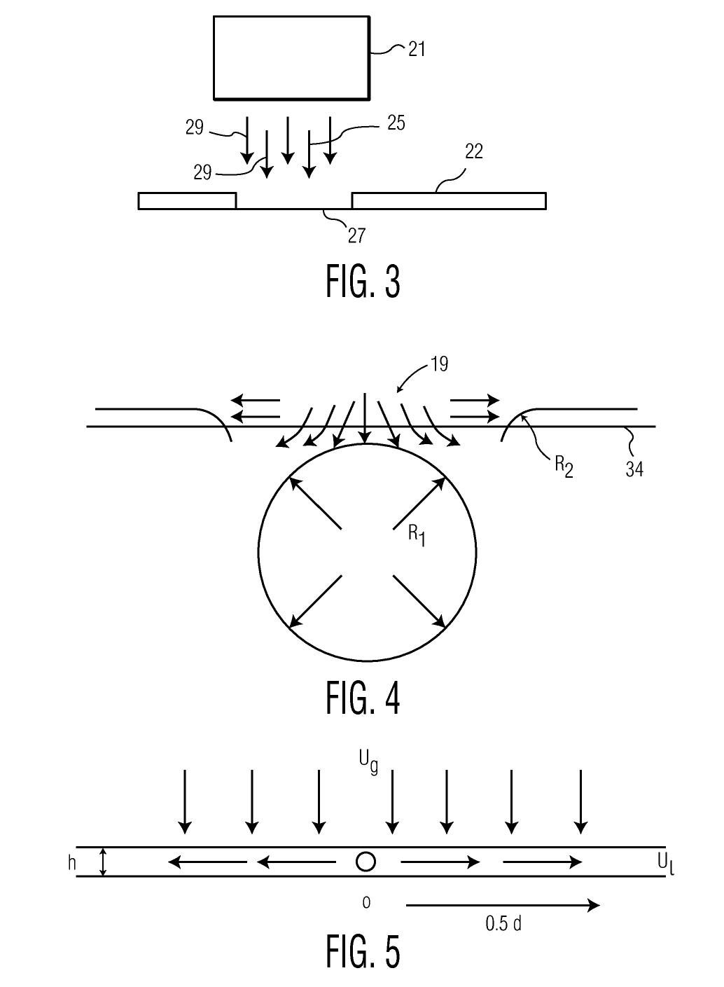

FIGS. 4-5 are diagrams illustrating the action of a gas jet on a liquid film.

As briefly discussed above, in the operation of a fluid droplet cleaning system for use in an oral care application, a liquid film develops on the teeth from the residue of the fluid droplets striking the teeth. This occurs regardless of droplet speed. This liquid film, which is present on the teeth in both the upper and lower jaw, but is more pronounced on the lower jaw teeth, interferes with and decreases the effect of the impact of subsequent fluid droplets in the fluid droplet stream, which may be continuous or in pulses, thereby adversely affecting the normal cleaning effect of the droplets.

This adverse effect will vary to some extent, depending upon the thickness of the film and the speed of the fluid droplets directed to the teeth, although there is some cleaning effect regardless of the film thickness and the speed of the droplets. It is known that even a relatively small thin film does have a strong influence on the maximum shear stress exerted by fluid droplets on plaque present on teeth. For instance, with a liquid film thickness of only 0.015 times the radius of the fluid droplets, the maximum shear stress produced by the fluid droplets on the plaque is reduced by a factor of 4. Further reductions in shear stress occur for thicker liquid films. Hence, material removal from the teeth, such as plaque, is severely affected by a liquid film.

In the present invention, a gas jet having a sufficiently high velocity is directed toward the thin film of liquid on the teeth to remove or significantly reduce the thickness of it. The gas, which can be air, but can be other types of gas as well, blows away a portion of the liquid, either producing a hole in the liquid film to the surface of the teeth, or significantly reducing the thickness of the liquid film in the desired area where subsequent fluid droplets will land.

In a first embodiment, shown in FIG. 1, an air jet source 10 is used with a conventional, high-speed, fluid droplet-generating system 12, with the air jet source 10 being separate from the droplet-generating system. The fluid droplets are directed toward a target such as the surface of teeth 14, or more specifically, plaque on the teeth. The fluid droplets may be generated by various known arrangements, such as shown in the '690 patent application.

The gas jet source 10, which can be a reservoir of pressurized gas at a pressure of 1.5 var-150 var, preferably 20-100 var, with a pressure regulator, includes a nozzle shown generally at 15 through which the gas exits. An air pump could be used as well. The gas jet source can include a single nozzle or a plurality of nozzles arranged around the periphery of the droplet-generating system 12. The nozzle can be arranged at an angle 17 to the surface of the teeth 14, with the angle being in the range of 60-70° from the surface of the teeth, up to and including a 90° angle, i.e. at right angles to the surface of the teeth, which in some cases is the most desirable. In the arrangement of FIG. 1, the source 10 and direction of the gas are separate from the droplet-generating system 12. The liquid layer is shown at 19.

In another embodiment shown in FIG. 3, where the droplet-generating system 20 includes a gas-assisted droplet generating system which accelerates the droplets to the desired high speed, the gas can be also used to clear an opening in the fluid film 22. In this arrangement, the fluid droplets 25 and/or the gas flow 29 can be operating in a pulse mode so that the fluid film cleaning function can alternate with the impact of fluid droplets.

As an alternative in this arrangement, separate air flow nozzles and/or air source can be used alongside, i.e. in close proximity to, the air-assisted droplet system.

Hence, gas flow can be used in various arrangements and in combination with various fluid droplet systems to provide an effective clearing of the impact area for subsequent fluid droplets.

FIG. 2 shows the impact of an air jet 19 from a gas source (not shown) on a fluid film 34. The exit gas jet nozzle is indicated at 30, with the air jet being directed at right angles to the liquid film 34, which has a particular height h on a surface to be cleaned 36, such as a tooth. In describing the effect of the gas jet on a liquid film, the system has an air jet with a diameter d, which impacts the liquid with a velocity V, on a film of liquid with thickness h, the liquid in the film having a density ρ, a dynamic viscosity μ, and a surface tension s.

As shown in FIGS. 2 and 4, air jet 19 deforms the liquid layer 34 in a curved pattern. The impacting air jet exerts a pressure on the liquid film. The liquid/air interface will change its shape, i.e. its curvature, as the air impacts the film. At equilibrium, the shape is established by the equation:

where R1 and R2 are the principal radii of curvature at the liquid/air interface, Pg is the pressure on the liquid film by the gas jet and P1 is the pressure in the liquid film.

FIG. 2 represents a situation where the gas jet pressure is constant over the diameter of the jet opening and outside that diameter the excess gas pressure is zero. The magnitude of the gas pressure can be found from the Bernoulli equation:
constant

In this arrangement, the velocity of the air jet has a component in the y direction which is outside the diameter of the actual originating gas jet diameter. There is a difference in action where the thickness of the liquid layer is similar to or smaller than the diameter of the gas jet in one case, and in another case where the liquid layer is much thicker than the diameter of the gas jet. In the first situation, the minimum gas pressure necessary to make a hole in the film will be smaller than the case where the liquid film is much thicker than the diameter of the gas jet.

The minimum velocity, in the case where the thickness of the film is small is provided by the following formula:

In such a case, with typical values of h=20 μm, d=0.5 mm, =0.07 N/m and =1.18 kg/m3, the minimum gas velocity will be approximately 12 m/s, which is quite low.

At the other extreme, where the liquid film is substantially thicker than the diameter of the jet:

With typical values such as set forth above, the velocity will be approximately 31 m/s. Hence, for a normal range of thickness, the gas velocity will be typically in the range of 12-31 m/s to accomplish the desired result of making a hole in the liquid film.

As indicated by the above formula, the value of gas pressure necessary to create a hole in the liquid film will increase as the liquid film thickness increases. For a liquid thickness of 1.5 mm, for example, which is on the order of the diameter of a traditional gas jet, the gas velocity necessary to create a hole in the liquid is approximately 16 m/s. The opening can be made much larger than the gas jet diameter, however, by increasing the gas pressure as well as the velocity.

The impacting gas jet on the liquid film generates a pressure difference which creates extra curvature in the liquid/air interface. When the radius of the hole increases, the velocity of the gas will decrease.

The horizontal gas velocity is V1(r) provided by the formula:

With a pressure difference of 3.3·103 Pa, and a gas jet radius of 1.1 mm, a radial velocity of approximately 5 m/s results. The generated pressure difference is typically 15 Pa. The curvature of the interface is defined by radius R1 and radius R2 (FIG. 4). R1 gives a larger pressure in the air, while R2 gives a larger pressure in the liquid. Typically due to the smaller radius of curvature of R1 than R2, however, the total curvature gives a larger pressure in the air, close to the calculated pressure of 15 Pa.

The above indicates that it is relatively easy to produce a hole in a liquid film at nearly all liquid thicknesses, with gas velocities in the range of 15-30 m/s, which are relatively low in a gas-assisted fluid droplet system. The diameter of the hole in the liquid layer can be made much larger than the diameter of the jet opening, depending upon the velocity and pressure of the gas.

Another significant issue besides the velocity of the gas is the time that is necessary for the gas to form a hole in the liquid, i.e. clearing a specified area in time for subsequent fluid droplets to be effective. Considering the arrangement shown in FIG. 5, where an air jet is directed toward a liquid film 40, at the center of the gas jet 42, the velocity in the liquid is zero (due to symmetry), and the pressure is equal to, 0.5 ρgV2 while at the edge of the gas jet (r=0.5 d), the pressure will be atmospheric. The velocity U1 in the liquid film is:

The flow rate of liquid Q that can be removed is the liquid velocity times the area of the liquid, which is:

The volume that needs to be removed is Vol=0.25 d2h, which results in a differential equation for a liquid thickness h:

such that:

where ho is equal to the initial thickness of the liquid film. Although this indicates that it takes a long time to remove, in reality, the thickness of the liquid film rapidly opens when it is decreased to the order of 20 nm. Accordingly, a liquid film that is initially 10 μm thick will thin down to 20 nm in a time of 3·10−4 s, with a gas velocity of 150 m/s and a jet diameter of 0.5 mm. For a 1.5 mm film, it would take approximately twice as long. Hence, the time for a gas jet to produce a liquid thinning fast enough to be effective for subsequent drops is quite possible.

Thus, a system has been disclosed which in a convenient and rapid manner produces a clearing of liquid film on surfaces such as teeth, produced in the operation of a fluid droplet and cleaning system. This present arrangement maintains the effectiveness of cleaning by liquid droplets.

Although a preferred embodiment of the invention has been disclosed for purposes of illustration, it should be understood that various changes, modifications and substitutions may be incorporated in the embodiment without departing from the spirit of the invention which is defined by the claims which follow.

1. A system for clearing the area of impact for a fluid droplet system used for oral cleaning of the teeth, comprising: a source of gas flow; and a gas flow directing member for directing the gas flow to an area on the teeth which has thereon a liquid film produced by fluid droplets, wherein the gas flow has a velocity which is high enough to significantly reduce the thickness of the liquid film so as to increase the efficiency of subsequent fluid droplets directed to the teeth for cleaning action.

2. The system of claim 1, wherein the gas flow has a sufficient velocity to clean a hole completely through the liquid film to the underlying tooth surface.

3. The system of claim 1, wherein the gas flow has a minimum velocity of 12 m/s.

4. The system of claim 1, wherein the gas flow is air.

5. The system of claim 1, wherein the gas flow is directed toward the liquid film on the teeth, at an angle of at least 60° relative to the surface of the teeth.

6. The system of claim 5, wherein the gas flow is directed substantially perpendicularly to the liquid film of the teeth.

7. The system of claim 1, wherein the gas flow is in the form of pulses of air directed toward the liquid film and the fluid droplets are also in the form of pulses.

8. The system of claim 1, wherein the gas flow is in the form of a continuous stream directed toward the liquid film.

9. The system of claim 1, wherein the source of gas flow is separate from the fluid droplet system.

10. The system of claim 1, wherein the fluid droplets are accelerated by a high-speed flow of gas, and wherein the high-speed gas flow is used to clear the liquid film in addition to accelerating the fluid droplets.

11. The system of claim 1, wherein the area of reduced thickness produced by the gas flow is larger than the size of the gas flow from the source thereof.

12. The system of claim 1, wherein the area of reduced thickness is substantially circular and curves outwardly at its edges.
